(19) United States
(12) Patent Application Publication
(10) Pub. No.: US 2007/0203401 A1
(43) Pub. Date: Aug. 30, 2007

(54) Method and apparatus for dynamically correlating neurological and cardiovascular parameters and for diagnosing and treating patients using the same

(76) Inventors: Bernard Gordon, Manchester, MA (US); James Levoy Sorenson, Salt Lake City, UT (US)

Correspondence Address: Mark J. Pandiscio;Pandiscio & Pandiscio, P.C., 470 Totten Pond Road, Waltham, MA, 02451-1914, US

(21) Appl. No.: 11/703,480

(22) Filed: Feb. 7, 2007

Related U.S. Application Data
(60) Provisional application No. 60/765,834, filed on Feb. 7, 2006.

(51) Int. Cl. G06F 19/00; G06Q 50/00

(52) U.S. Cl. 600/300; 702/20; 705/2

(57) ABSTRACT

A novel method and apparatus for dynamically correlating neurological and cardiovascular parameters and for diagnosing and treating patients using the same.

### REFERENCE TO PENDING PRIOR PATENT APPLICATION

This patent application claims benefit of pending prior U.S. Provisional Patent Application Ser. No. 60/765,834, filed Feb. 7, 2006 by Bernard Gordon et al. for METHOD AND APPARATUS FOR DYNAMICALLY CORRELATING NEUROLOGICAL AND CARDIOVASCULAR PARAMETERS AND FOR DIAGNOSING AND TREATING PATIENTS USING THE SAME (Attorney's Docket No. NEUROLOGICA-22 PROV), which patent application is hereby incorporated herein by reference.

### FIELD OF THE INVENTION

This invention relates to medical methods and apparatus in general, and more particularly to methods and apparatus for correlating anatomical parameters to one another and for diagnosing and treating patients, and/or otherwise preventing medical disorders, using the same.

### BACKGROUND OF THE INVENTION

During the past several decades, and particularly since the introduction of high-speed, high-precision analog-to-digital conversion techniques, there have been substantial developments in methods and apparatus for measuring and/or imaging specific neurological parameters and also for measuring and/or imaging specific cardiovascular parameters. In general, researchers and/or medical practitioners, depending on their individual fields of interest, have utilized relatively individualized (i.e., singular) methodologies to measure or image specific anatomical parameters. For imaging purposes, these methodologies have utilized the imaging capabilities of X-ray computer-assisted tomography (CT), magnetic resonance imaging (MRI), ultrasound, positron emission tomography (PET), single photon emission computed tomography (SPECT), nuclear medicine, cryogenic magnetic phenomena, etc. Other measuring systems have utilized heart rate monitors, ultrasonic Doppler systems, optical measuring systems, electrocardiographs, electroencephalographs, electrical tomography, etc. The literature is replete with various studies which have been made utilizing these available techniques.

However, it appears that there have not heretofore existed methods or apparatus capable of simultaneously recording various neurological and cardiovascular parameters and dynamically identifying interrelationships between such neurological and cardiovascular parameters, in order to diagnose and treat patients, and/or otherwise prevent medical disorders, based on the same. Among other things, there does not appear to have heretofore existed methods or apparatus for simultaneously determining various electrical, chemical, electro-chemical and/or mechanical parameters of both the neurological and cardiovascular systems, and for dynamically correlating the same, so as to identify interrelationships between the neurological and cardiovascular systems, whereby to diagnose and treat patients, and/or otherwise prevent medical disorders, using the same.

### SUMMARY OF THE INVENTION

As a result, one objective of the present invention is to provide a novel system for simultaneously determining both the neurological and cardiovascular parameters of a patient, and for dynamically identifying interrelationships between the neurological and cardiovascular systems, so as to provide hitherto unavailable data and information to medical practioners, whereby to enhance the diagnosis and treatment of patients, and/or otherwise prevent medical disorders. Among other things, identifying interrelationships between neurological and cardiovascular parameters can permit a better understanding of the possible causes and effects of anxiety, depression, compulsive behavior, sleep apnea, post-traumatic stress disorder, and other medical conditions, and can permit improved diagnosis and treatment of the same, and/or otherwise prevent medical disorders.

To this end, there is provided a novel method and apparatus for dynamically correlating neurological and cardiovascular parameters and for diagnosing and treating patients, and/or otherwise preventing medical disorders, using the same.

More particularly, in one form of the invention, there is provided a novel method for dynamically correlating neurological and cardiovascular parameters and for diagnosing and treating patients, and/or otherwise preventing medical disorders, using the same.

In another form of the invention, there is provided a novel apparatus for dynamically correlating neurological and cardiovascular parameters and for diagnosing and treating patients, and/or otherwise preventing medical disorders, using the same.

In another form of the invention, there is provided a method for identifying an interrelationship between the neurological and cardiovascular systems of a patient, comprising:

detecting at least one neurological parameter of the patient;

detecting at least one cardiovascular parameter of the patient; and

dynamically correlating at least one of the detected neurological parameters and at least one of the detected cardiovascular parameters, and using the same so as to identify an interrelationship between the neurological and cardiovascular systems of the patient.

In another form of the invention, there is provided a method for identifying an interrelationship between the neurological system and biological bearing of a patient, comprising:

detecting at least one neurological parameter of the patient;

detecting at least one biological parameter of the patient; and

dynamically correlating at least one of the detected neurological parameters and at least one of the detected biological parameters, and using the same so as to identify an interrelationship between the neurological system and biological bearing of the patient.

In another form of the invention, there is provided a method for identifying an interrelationship between the cardiovascular system and biological bearing of a patient, comprising:

detecting at least one cardiovascular parameter of the patient;

detecting at least one biological parameter of the patient; and

dynamically correlating at least one of the detected cardiovascular parameters and at least one of the detected biological parameters, and using the same so as to identify an interrelationship between the cardiovascular system and biological bearing of the patient.

In another form of the invention, there is provided an apparatus for identifying an interrelationship between the neurological and cardiovascular systems of a patient, comprising:

neurological apparatus for detecting at least one neurological parameter of the patient;

cardiovascular apparatus for detecting at least one cardiovascular parameter of the patient; and

computing apparatus for dynamically correlating at least one of the detected neurological parameters and at least one of the detected cardiovascular parameters, and using the same so as to identify an interrelationship between the neurological and cardiovascular systems of the patient.

In another form of the invention, there is provided a method for identifying an interrelationship between first and second anatomical systems of a patient, comprising:

detecting at least one parameter of the first anatomical system of the patient;

detecting at least one parameter of the second anatomical system of the patient; and

dynamically correlating at least one of the detected parameters of the first anatomical system and at least one of the detected parameters of the second anatomical system, and using the same so as to identify an interrelationship between the first and second anatomical systems of the patient.

In another form of the invention, there is provided an apparatus for identifying an interrelationship between first and second anatomical systems of a patient, comprising:

apparatus for detecting at least one parameter of the first anatomical system of the patient;

apparatus for detecting at least one parameter of the second anatomical system of the patient; and

computing apparatus for dynamically correlating at least one of the detected parameters of the first anatomical system and at least one of the detected parameters of the second anatomical system, and using the same so as to identify an interrelationship between the first and second anatomical systems of the patient.

### BRIEF DESCRIPTION OF THE DRAWINGS

These and other objects and features of the present invention will be more fully disclosed or rendered obvious by the following detailed description of exemplary embodiments of the invention, which are to be considered together with the accompanying drawings wherein like numbers refer to like parts and further wherein:

FIG. 1 is a schematic diagram illustrating a prior art technique of using functional MRI and an induced stimulus to evaluate neurological parameters (but lacking any related evaluation of cardiovascular parameters);

FIG. 2 is a schematic diagram illustrating a prior art technique of using CT to evaluate cardiovascular parameters (but lacking any related evaluation of neurological parameters);

FIG. 3 is a schematic diagram illustrating the novel technique of the present invention of dynamically correlating both neurological and cardiovascular parameters so as to identify interrelationships between the neurological and cardiovascular systems;

FIG. 4 is a schematic diagram illustrating an example of how the present invention uses a CT scanner and other apparatus to correlate neurological and cardiovascular parameters;

FIG. 5 is a schematic diagram illustrating an example of how the present invention uses a functional MRI scanner and other apparatus to correlate neurological and cardiovascular parameters;

FIG. 6 is a schematic diagram illustrating an example of how the present invention uses a SPECT scanner and other apparatus to correlate neurological and cardiovascular parameters;

FIG. 7 is a schematic diagram illustrating an example of how the present invention uses various data acquisition devices to correlate neurological and cardiovascular parameters in a sleep apnea system; and

FIG. 8 is a schematic diagram illustrating an example of various data which may be acquired by the novel system of the present invention.

### DETAILED DESCRIPTION OF THE EXEMPLARY EMBODIMENTS

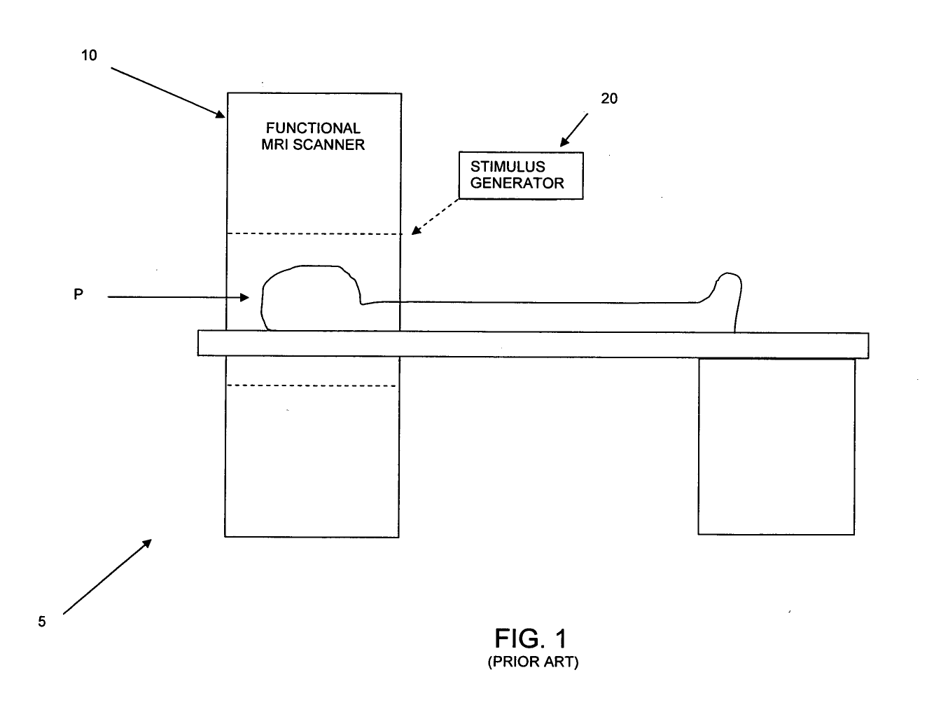

Looking first at FIG. 1, there is shown a prior art system 5 which uses functional MRI and a stimulus to evaluate neurological parameters. More particularly, system 5 comprises a functional MRI scanner 10 which is adapted to acquire data about the neurological parameters of a patient P. While the patient is undergoing functional MRI scanning, a stimulus generator 20 is used to stimulate the patient's neurological system. Stimulus generator 20 may be configured to stimulate the patient with various lights, sounds, smells, tastes, temperature, physical contacts, images and visualized situations (including, but not limited to, emotion-inducing images and visualized situations), etc. While the patient's neurological system is stimulated using stimulus generator 20, the patient's neurological system is simultaneously observed using functional MRI scanner 10 and changes to the patient's neurological system are recorded. These changes to the patient's neurological parameters are correlated to the specific stimulations applied to the patient's neurological system and conclusions drawn regarding the patient's neurological system. This knowledge may then be used to diagnose and/or treat the patient. Significantly, with the prior art system of FIG. 1, while there is evaluation of the patient's neurological parameters, there is no related evaluation of the patient's cardiovascular parameters.

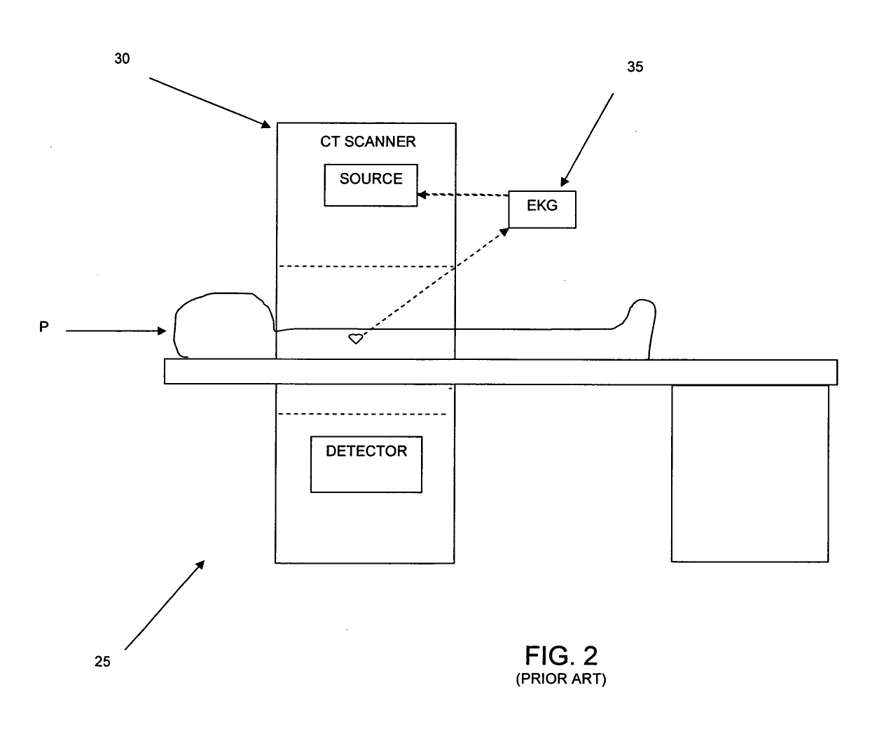

Looking next at FIG. 2, there is shown a prior art system 25 which uses CT to evaluate cardiovascular parameters. More particularly, system 25 comprises a CT scanner 30 which is adapted to acquire data about the cardiovascular parameters of a patient P. In order to synchronize the relatively slow CT scanner with the relatively fast heartbeats of the patient, a heart rate monitor 35 (e.g., an EKG machine) may be used to detect the heartbeats of the patient and trigger CT scanner 30 (i.e., in a manner somewhat analogous to the use of a stroboscope in high speed photography). The images acquired by CT scanner 30 are analyzed and conclusions drawn regarding the patient's cardiovascular system. This knowledge may then be used to diagnose and/or treat the patient. Significantly, with the prior art system of FIG. 2, while there is evaluation of the patient's cardiovascular system, there is no related evaluation of the patient's neurological system.

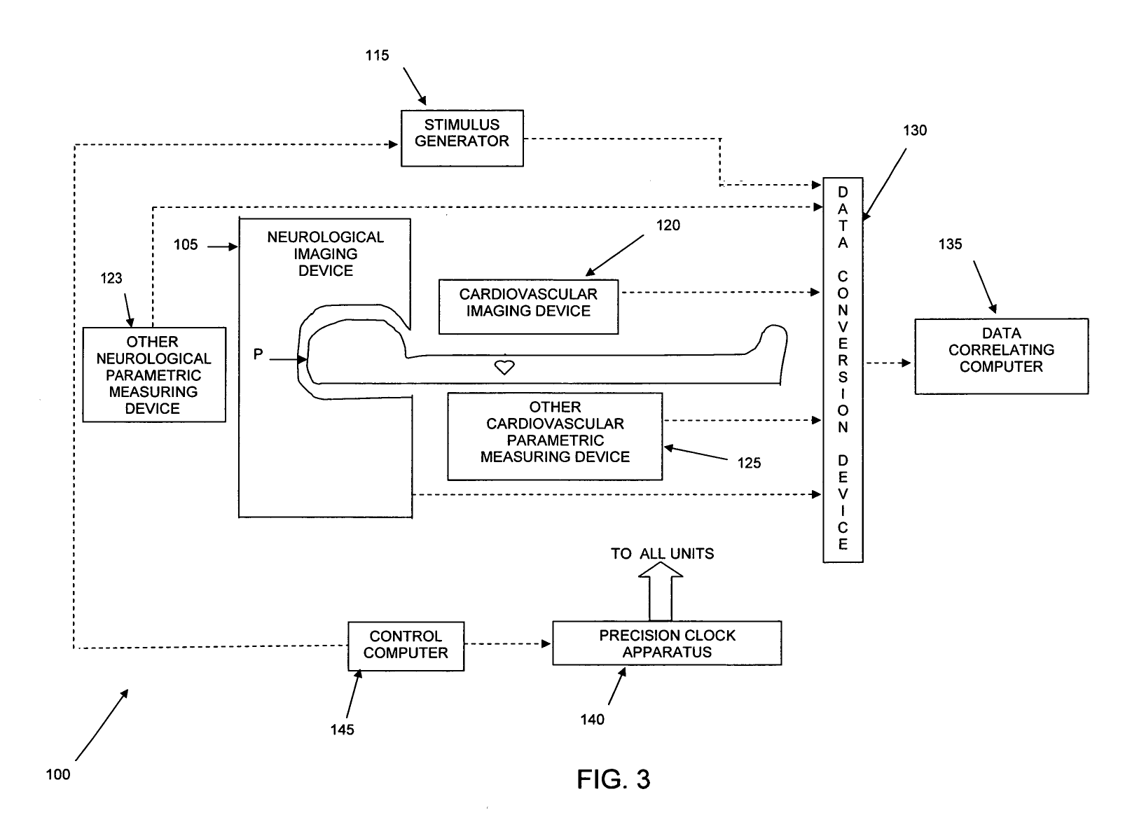

Looking next at FIG. 3, there is shown a novel system 100 which provides a method and apparatus for dynamically correlating both neurological and cardiovascular parameters so as to identify interrelationships between the neurological and cardiovascular systems of the patient and for diagnosing and treating patients, and/or otherwise preventing medical disorders, using the same.

More particularly, system 100 preferably comprises a neurological imaging device 105 which is adapted to acquire image data about the neurological parameters of a patient P, a stimulus generator 115 which is adapted to provide a stimulus to the patient, and a cardiovascular imaging device 120 which is adapted to acquire image data about the cardiovascular parameters of the patient. By way of example but not limitation, neurological imaging device 105 and/or cardiovascular imaging device 120 may comprise X-ray computer-assisted tomography (CT) scanners, magnetic resonance imaging (MRI) scanners, ultrasound devices, positron emission tomography (PET) scanners, single photon emission computed tomography (SPECT) scanners, nuclear medicine devices, cryogenic magnetic phenomena devices, etc.; and stimulus generator 115 may comprise apparatus configured to stimulate the patient with various lights, sounds, smells, tastes, temperature, physical contacts, images and visualized situations (including, but not limited to, emotion-inducing images and visualized situations), etc.

System 100 may also comprise other neurological parametric measuring devices 123 (e.g., an EEG device, an electrical tomography system, etc.) and/or other cardiovascular parametric measuring devices 125 (e.g., a heart rate monitor, an ultrasonic Doppler system, an optical measuring system, an electrocardiograph, etc.).

The data outputs of neurological imaging device 105, cardiovascular imaging device 120, other neurological parametric measuring devices 123 and other cardiovascular parametric measuring devices 125 are connected to a data conversion device 130, where the data is regularized into a useful digital format, before being passed to a data correlating computer 135.

System 100 also comprises a precision clock apparatus 140 connected to neurological imaging device 105, stimulus generator 115, cardiovascular imaging device 120, other neurological parametric measuring devices 123 and other cardiovascular parametric measuring devices 125, data conversion device 130 and data correlating computer 135. Furthermore, system 100 comprises a control computer 145 for operating system 100.

In accordance with the present invention, control computer 145 is used to simultaneously operate neurological imaging device 105, stimulus generator 115, cardiovascular imaging device 120, other neurological parametric measuring devices 123 and/or other cardiovascular parametric measuring devices 125 so as to obtain data regarding the patient's neurological and cardiovascular parameters. This data is passed through data conversion device 130 to correlating computer 135, where correlations are identified between the patient's neurological and cardiovascular parameters and conclusions drawn regarding interrelationships between the patient's neurological and cardiovascular systems. This knowledge may then be used to diagnose and/or treat the patient, and/or otherwise prevent medical disorders.

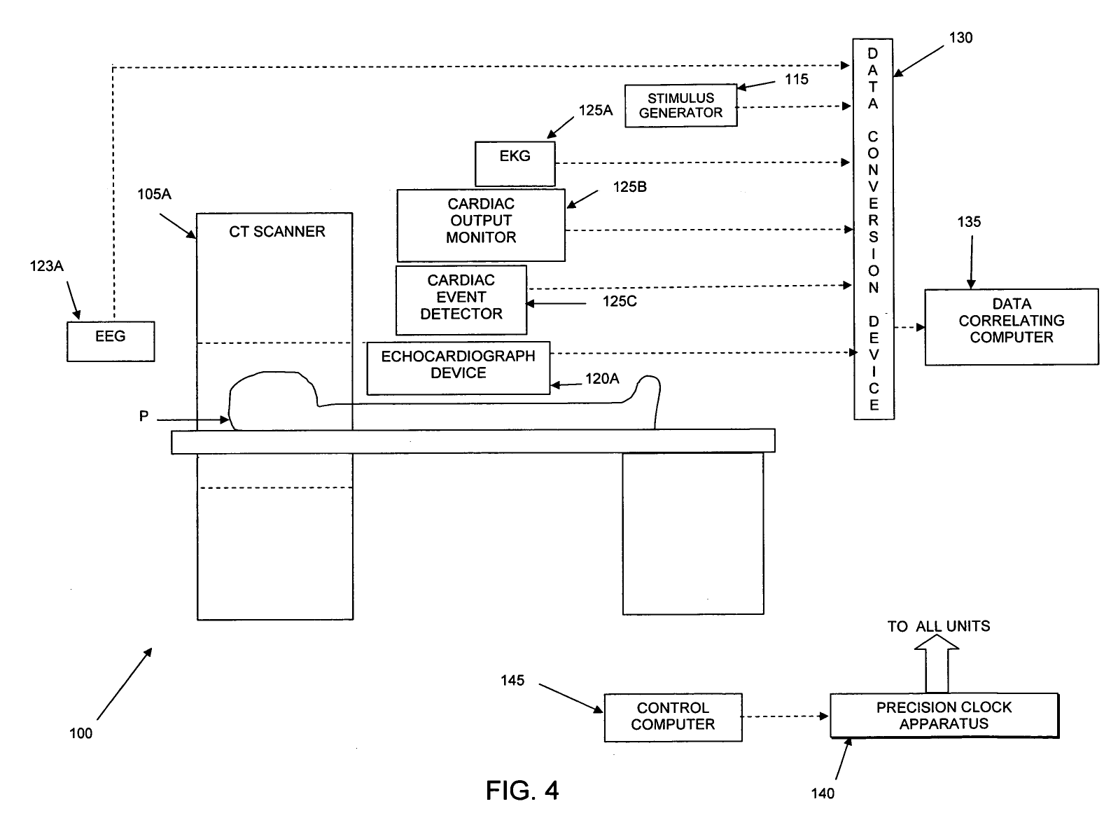

Looking next at FIG. 4, there is shown an exemplary embodiment of the novel system 100 which uses a CT scanner. More particularly, in this form of the invention, system 100 comprises a CT scanner 105A which is adapted to acquire image data about the neurological parameters of a patient P, a stimulus generator 115 which is adapted to provide a stimulus to the patient, and an echocardiograph device 120A which is adapted to acquire image data about the cardiovascular parameters of the patient. System 100 may also comprise other neurological parametric measuring devices, e.g., an EEG monitor 123A. And system 100 may also comprise other cardiovascular parametric measuring devices, e.g., an EKG monitor 125A, a cardiac output monitor 125B, a cardiac event detector 125C, etc. Again, data conversion device 130, data correlating computer 135, precision clock apparatus 140 and control computer 145 are provided. In accordance with the present invention, system 100 collects data regarding the patient's neurological and cardiovascular parameters and identifies correlations between the patient's neurological and cardiovascular parameters, so that conclusions may be drawn regarding interrelationships between the patient's neurological and cardiovascular systems. This knowledge may then be used to diagnose and/or treat the patient, and/or otherwise prevent medical disorders.

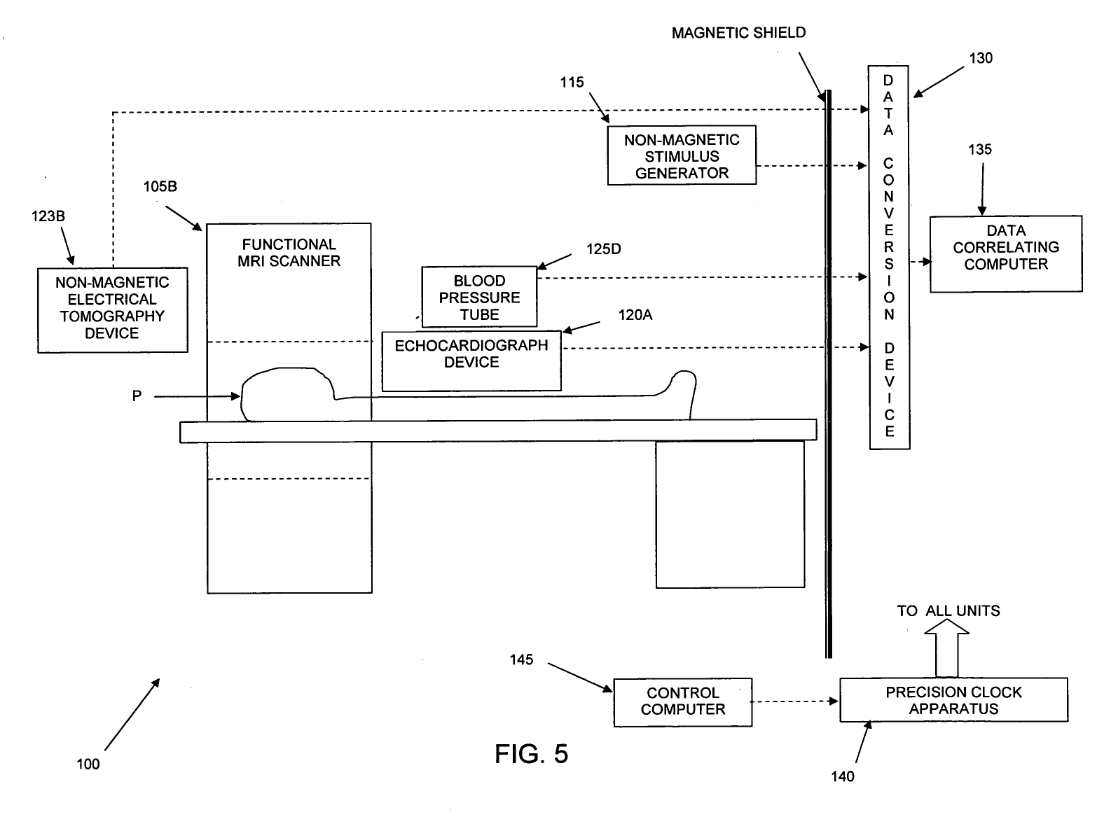

Looking next at FIG. 5, there is shown an exemplary embodiment of the novel system 100 which uses a functional MRI scanner. More particularly, in this form of the invention, system 100 comprises a functional MRI scanner 105B which is adapted to acquire image data about the neurological parameters of a patient P, a stimulus generator 115 which is adapted to provide a stimulus to the patient, and an echocardiograph device 120A for acquiring image data about the cardiovascular parameters of the patient P. System 100 also comprises other neurological parametric measuring devices, e.g. an electrical tomography device 123B. And system 100 may also comprise other cardiovascular parametric measuring devices, e.g. a blood pressure tube 125D. Again, data conversion device 130, data correlating computer 135, precision clock apparatus 140 and control computer 145 are provided. In accordance with the present invention, system 100 collects data regarding the patient's neurological and cardiovascular parameters and identifies correlations between the patient's neurological and cardiovascular parameters, so that conclusions may be drawn regarding interrelationships between the patient's neurological and cardiovascular systems. This knowledge may then be used to diagnose and/or treat the patient, and/or otherwise prevent medical disorders.

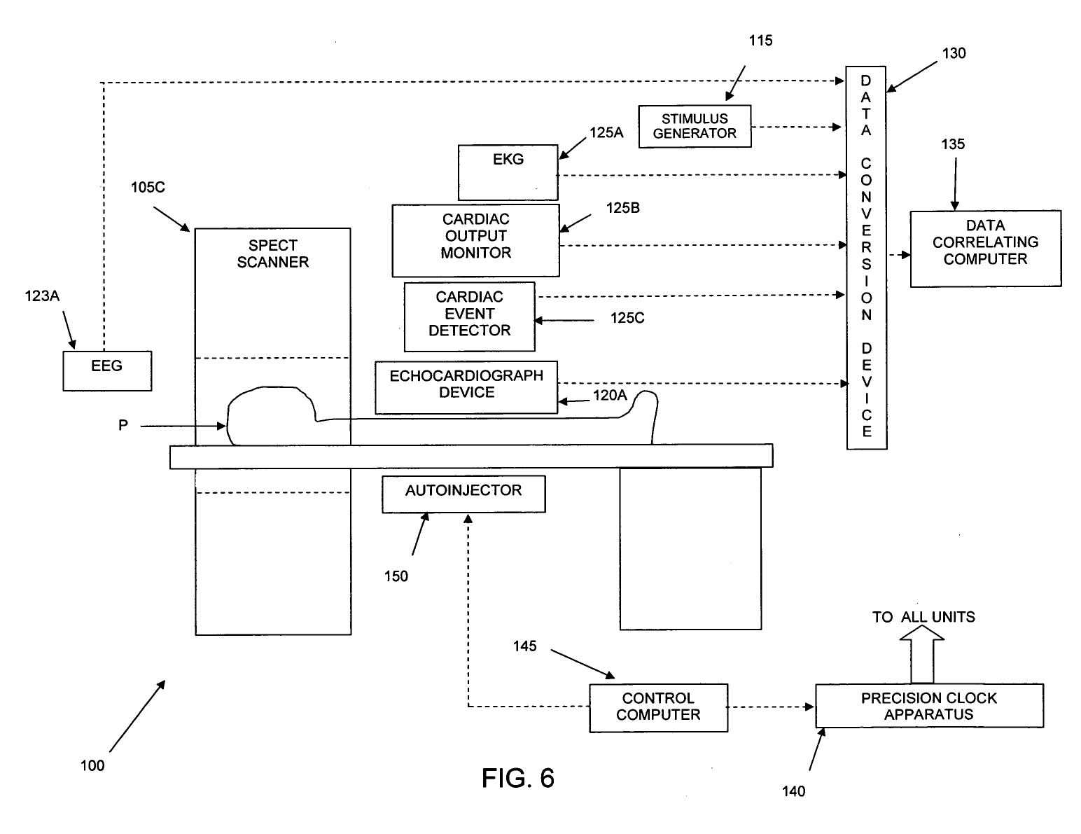

Looking next at FIG. 6, there is shown an exemplary embodiment of the novel system 100 which uses a SPECT scanner. More particularly, in this form of the invention, system 100 comprises a SPECT scanner 105C which is adapted to acquire image data about the neurological parameters of a patient P, an autoinjector 150 for injecting a radiation source into the patient's body so as to enable SPECT scanning, a stimulus generator 115 which is adapted to provide a stimulus to the patient, and an echocardiograph device 120A which is adapted to acquire image data about the cardiovascular parameters of the patient. System 100 may also comprise other neurological parametric measuring devices, e.g., an EEG monitor 123A. And system 100 may also comprise other cardiovascular measuring devices, e.g. an EKG monitor 125A, a cardiac output monitor 125B, a cardiac event detector 125C, etc. Again, data conversion device 130, data correlating computer 135, precision clock apparatus 140 and control computer 145 are provided. In accordance with the present invention, system 100 collects data regarding the patient's neurological and cardiovascular parameters and identifies correlations between the patient's neurological and cardiovascular parameters, so that conclusions may be drawn regarding interrelationships between the patient's neurological and cardiovascular systems. This knowledge may then be used to diagnose and/or treat the patient, and/or otherwise prevent medical disorders.

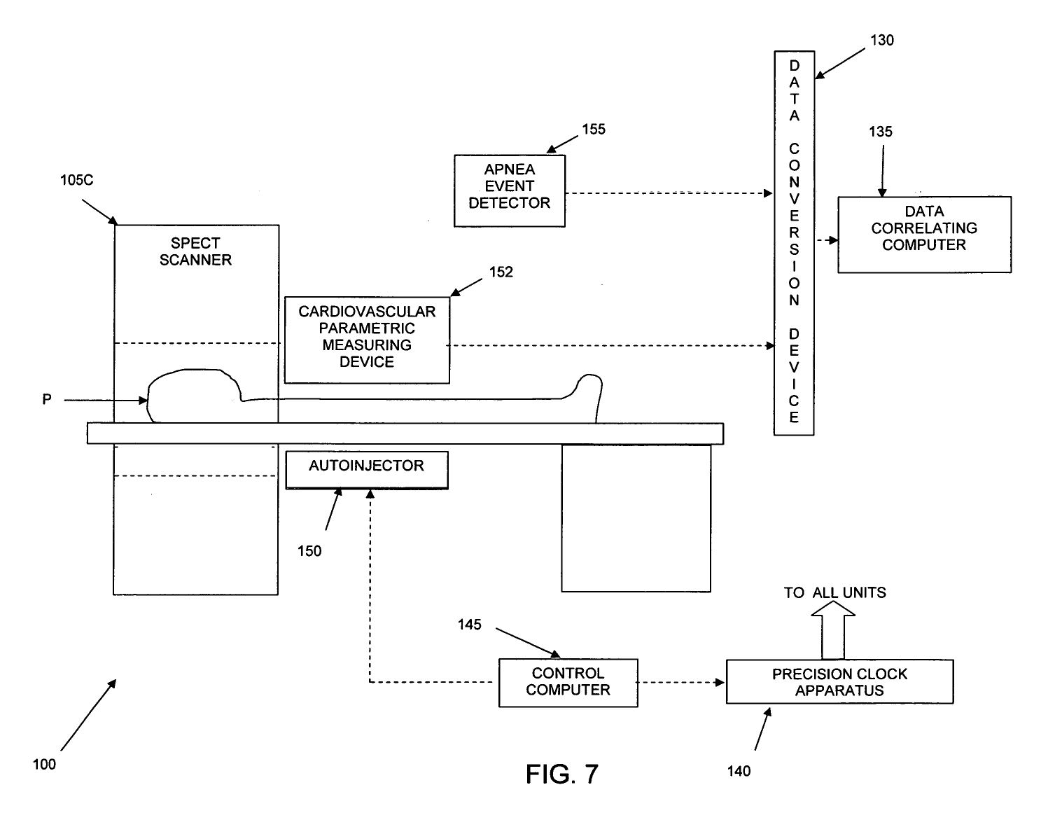

Looking next at FIG. 7, there is shown an exemplary embodiment of the novel system 100 which is configured to test the patient for sleep apnea. More particularly, in this form of the invention, system 100 comprises a SPECT scanner 105C which is adapted to acquire image data about the neurological parameters of a patient P, an autoinjector 150 for injecting a radiation source into the patient's body so as to enable SPECT scanning, a cardiovascular parametric measuring device 152 which is adapted to acquire data with respect to the patient's cardiovascular system (e.g., a blood pressure detector, a pulse rate detector, an EKG detector, a cardiac output detector, etc.), and an apnea event detector 155 (e.g., a breathing monitor, an oxygen saturation detector, etc). Again, data conversion device 130, data correlating computer 135, precision clock apparatus 140 and control computer 145 are provided. In accordance with the present invention, system 100 collects data regarding the patient's neurological and cardiovascular parameters and identifies correlations between the patient's neurological and cardiovascular parameters, so that conclusions may be drawn regarding interrelationships between the patient's neurological and cardiovascular systems. This knowledge may then be used to diagnose and/or treat the patient, and/or otherwise prevent medical disorders.

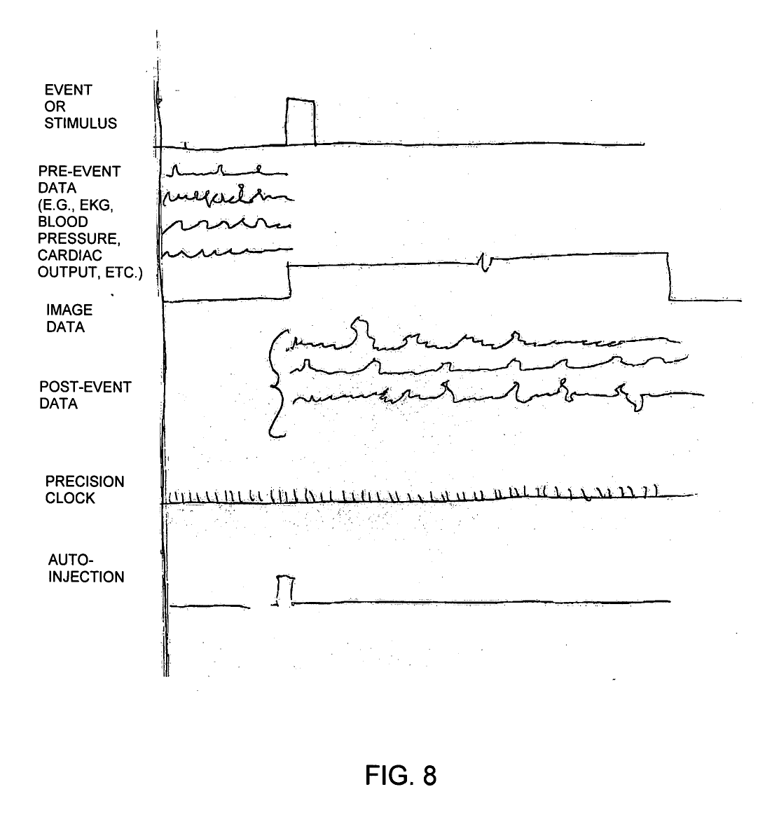

FIG. 8 is an example of the type of generalized data set which may be sent to data conversion device 130.

### APPLICATION OF THE PRESENT INVENTION TO ADDITIONAL ANATOMICAL SYSTEMS

In the foregoing description, the present invention is discussed in the context of identifying interrelationships between the neurological and cardiovascular systems of a patient. However, it should also be appreciated that the present invention may be applied to additional anatomical systems, such as the digestive system, the lymphatic system, the respiratory system, the reproductive system, the muscular system, the urinary system, etc.

### APPLICATION OF THE PRESENT INVENTION TO NON-HUMAN PATIENTS

It should be appreciated that the present invention may be applied to non-humans (i.e., household pets such as dogs and cats, large animals such as horses and cows, other intelligent animal life such as chimpanzees, whales, dolphins and the like, etc.) as well as to humans. To this end, the term “patient” as used herein is intended to have the broadest possible meaning consistent with the present invention.

Diagnosis, Treatment and/or Otherwise Preventing Medical Disorders

The present invention makes it possible to identify interrelationships between the patient's neurological and cardiovascular systems, and/or between other systems. This information may then be used to diagnosis, treat and/or otherwise prevent medical disorders. Such treatment or prevention may constitute medical treatment, including a dynamic combination of dosage, regime or protocol. Furthermore, such treatment or prevention may constitute holistic methodologies, either individually or in combination with others. Such holistic methodologies may consist of spiritual conditioning, acupuncture or stimulation of senses.

### MODIFICATIONS

It is to be understood that the present invention is by no means limited to the particular constructions herein disclosed and/or shown in the drawings, but also comprises any modifications or equivalents within the scope of the invention.

What is claimed is:

1. A method for identifying an interrelationship between the neurological and cardiovascular systems of a patient, comprising:
detecting at least one neurological parameter of the patient;
detecting at least one cardiovascular parameter of the patient; and
dynamically correlating at least one of the detected neurological parameters and at least one of the detected cardiovascular parameters, and using the same so as to identify an interrelationship between the neurological and cardiovascular systems of the patient.

2. The method of claim 1 wherein identification of the interrelationship between the neurological and cardiovascular systems of the patient is utilized to treat at least one undesired symptom of the patient.

3. The method of claim 2 wherein said symptom relates to depression.

4. The method of claim 2 wherein the treatment is primarily medical.

5. The method of claim 4 wherein the medical treatment comprises a dynamic combination of dosage, regime or protocol.

6. The method of claim 1 wherein identification of the interrelationship between the neurological and cardiovascular systems of the patient is utilized to prevent at least one undesired condition of the patient.

7. The method of claim 6 wherein said condition relates to depression.

8. The method of claim 6 wherein prevention is achieved by primarily medical treatment.

9. The method of claim 8 wherein said medical treatment comprises a dynamic combination of dosage, regime or protocol.

10. The method of claim 6 wherein prevention of said condition primarily comprises a holistic methodology individually or in combination with at least one other holistic methodology.

11. The method of claim 10 wherein said holistic methodology comprises spiritual conditioning, acupuncture or stimulation of senses.

12. The method of claim 11 wherein said senses include visual, olfactory, tactile, auditory and taste senses.

13. The method of claims 1 wherein said dynamic correlation is undertaken concurrent with, and responsive to, at least one external stimulus to the patient.

14. A method for identifying an interrelationship between the neurological system and biological bearing of a patient, comprising:
detecting at least one neurological parameter of the patient;
detecting at least one biological parameter of the patient; and
dynamically correlating at least one of the detected neurological parameters and at least one of the detected biological parameters, and using the same so as to identify an interrelationship between the neurological system and biological bearing of the patient.

15. The method of claims 14 wherein the biological bearing comprises a genetic profile of the patient.

16. The method of claim 15 wherein the genetic profile comprises any one marker or combination of a plurality of markers suggesting a predisposition of the patient toward a condition.

17. The method of claim 16 wherein identification of the interrelationship facilitates prevention, diagnosis, treatment of or other desired therapeutic approach to the condition.

18. The method of claim 16 wherein the condition is a recognizable, measurable or observable phenotype or genotype.

19. The method of claims 14 wherein said dynamic correlation is undertaken concurrent with, and responsive to, at least one external stimulus to the patient.

20. A method for identifying an interrelationship between the cardiovascular system and biological bearing of a patient, comprising:
detecting at least one cardiovascular parameter of the patient;
detecting at least one biological parameter of the patient; and
dynamically correlating at least one of the detected cardiovascular parameters and at least one of the detected biological parameters, and using the same so as to identify an interrelationship between the cardiovascular system and biological bearing of the patient.

21. The method of claims 20 wherein the biological bearing comprises a genetic profile of the patient.

22. The method of claim 21 wherein the genetic profile comprises any one marker or combination of a plurality of markers suggesting a predisposition of the patient toward a condition.

23. The method of claim 22 wherein identification of the interrelationship facilitates prevention, diagnosis, treatment of or other desired therapeutic approach to the condition.

24. The method of claim 22 wherein the condition is a recognizable, measurable or observable phenotype or genotype.

25. The method of claims 20 wherein said dynamic correlation is undertaken concurrent with, and responsive to, at least one external stimulus to the patient.

26. Apparatus for identifying an interrelationship between the neurological and cardiovascular systems of a patient, comprising:
neurological apparatus for detecting at least one neurological parameter of the patient;
cardiovascular apparatus for detecting at least one cardiovascular parameter of the patient; and
computing apparatus for dynamically correlating at least one of the detected neurological parameters and at least one of the detected cardiovascular parameters, and using the same so as to identify an interrelationship between the neurological and cardiovascular systems of the patient.

27. A method for identifying an interrelationship between first and second anatomical systems of a patient, comprising:
detecting at least one parameter of the first anatomical system of the patient;
detecting at least one parameter of the second anatomical system of the patient; and
dynamically correlating at least one of the detected parameters of the first anatomical system and at least one of the detected parameters of the second anatomical system, and using the same so as to identify an interrelationship between the first and second anatomical systems of the patient.

28. Apparatus for identifying an interrelationship between first and second anatomical systems of a patient, comprising:
apparatus for detecting at least one parameter of the first anatomical system of the patient;
apparatus for detecting at least one parameter of the second anatomical system of the patient; and
computing apparatus for dynamically correlating at least one of the detected parameters of the first anatomical system and at least one of the detected parameters of the second anatomical system, and using the same so as to identify an interrelationship between the first and second anatomical systems of the patient.

29. A novel method for dynamically correlating neurological and cardiovascular parameters and for diagnosing and treating patients using the same.

30. A novel apparatus for dynamically correlating neurological and cardiovascular parameters and for diagnosing and treating patients using the same.
